(19) United States
(12) Patent Application Publication
(10) Pub. No.: US 2006/0107054 A1
(43) Pub. Date: May 18, 2006

(54) Method, apparatus and system to authenticate chipset patches with cryptographic signatures

(76) Inventor: David Walter Young, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/990,675

(22) Filed: Nov. 16, 2004

(51) Int. Cl. H04L 9/00

(52) U.S. Cl. 713/176

(57) ABSTRACT

In some embodiments, a method, apparatus and system to authenticate chipset patches with cryptographic signatures are presented. In this regard, an authentication agent is introduced to lock values in chipset identification registers, to authenticate a signature of a chipset patch, and to validate the chipset patch. Other embodiments are also disclosed and claimed.

### FIELD OF THE INVENTION

Embodiments of the present invention generally relate to the field of security, and, more particularly to a method, apparatus and system to authenticate chipset patches with cryptographic signatures.

### BACKGROUND OF THE INVENTION

An electronic appliance may include circuitry known as a chipset which provides for interconnection and communication between components, such as controllers, memory devices, and input/output devices, for example. It may be necessary for a manufacturer to provide an updated chipset patch, which is software that configures the chipset, in order to address errata or to improve performance. Traditional chipset patches are not authenticated and are poorly encrypted. This leaves the chipset patch susceptible to use in various attacks against platform security.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing an authentication agent, in accordance with one example embodiment of the invention;

FIG. 2 is a block diagram of an example authentication agent architecture, in accordance with one example embodiment of the invention;

FIG. 3 is a flow chart of an example method to authenticate chipset patches with cryptographic signatures, in accordance with one example embodiment of the invention; and

FIG. 4 is a block diagram of an example storage medium comprising content which, when accessed by a device, causes the device to implement one or more aspects of one or more embodiment(s) of the invention.

### DETAILED DESCRIPTION

Embodiments of the present invention are generally directed to a method, apparatus and system to authenticate chipset patches with cryptographic signatures. In this regard, in accordance with but one example implementation of the broader teachings of the present invention, an authentication agent is introduced. In accordance with but one example embodiment, the authentication agent employs an innovative method to lock values in chipset identification registers, to authenticate a signature of a chipset patch, and to validate the chipset patch based at least in part on the locked values. According to one example method, the authentication agent may utilize stored secrets within an electronic appliance. According to another example method, the authentication agent may include software that operates in a protected execution environment.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

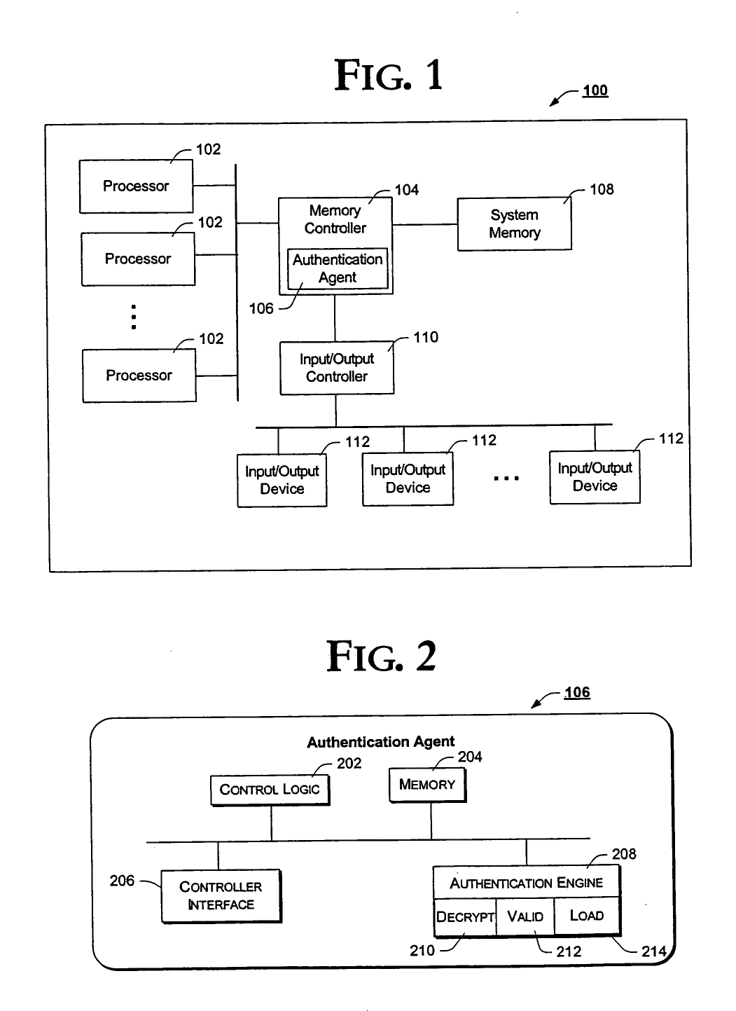

FIG. 1 is a block diagram of an example electronic appliance suitable for implementing an authentication agent, in accordance with one example embodiment of the invention. Electronic appliance 100 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, authentication agent 106, system memory 108, input/output controller 110, and input/output device(s) 112 coupled as shown in FIG. 1. Authentication agent 106, as described more fully hereinafter, may well be used in electronic appliances of greater or lesser complexity than that depicted in FIG. 1. Also, the innovative attributes of authentication agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, processor(s) 102 may contain security technology code-named LaGrande Technology. In another embodiment, processor(s) 102 may include cryptographic logic such as an authenticated code module (ACM).

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge. Memory controller 104 may have identification registers which identify a currently utilized chipset patch with such information as an original equipment manufacturer (OEM) identifier and version number. Memory controller 104 may also have configuration registers which control the operating settings of memory controller 104.

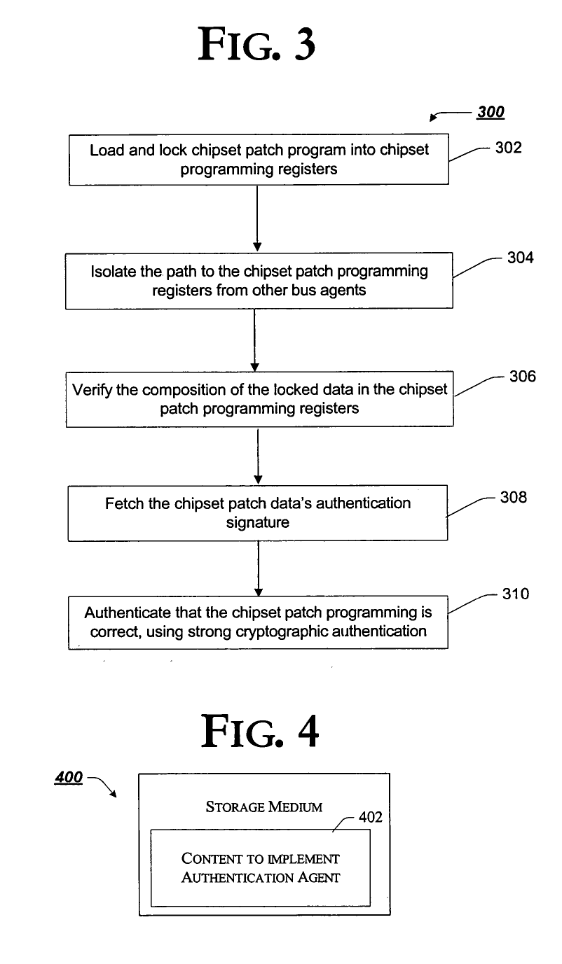

Authentication agent 106 may have an architecture as described in greater detail with reference to FIG. 2. Authentication agent 106 may also perform one or more methods to authenticate chipset patches with cryptographic signatures, such as the method described in greater detail with reference to FIG. 3. While shown as being part of memory controller 104, authentication agent 106 may well be part of another component, for example processor(s) 102 or input/output controller 110, or may be implemented in software or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM). The present invention, however, is not limited to the examples of memory mentioned here.

Input/output (I/O) controller 110 may represent any type of chipset or control logic that interfaces I/O device(s) 112 with the other components of electronic appliance 100. In one embodiment, I/O controller 110 may be refefred to as a south bridge. In another embodiment, I/O controller 110 may comply with the Peripheral Component Interconnect (PCI) Express™ Base Specification, Revision 1.0a, PCI Special Interest Group, released Apr. 15, 2003. I/O controller 110 may have internal status registers relating to its operation and the operation of I/O device(s) 112.

Input/output (I/O) device(s) 112 may represent any type of device, peripheral or component that provides input to or processes output from electronic appliance 100. In one embodiment, though the present invention is not so limited, I/O device(s) 112 may include a network controller, such as a wired or a wireless network controller. In another embodiment, one I/O device 112 may be a version 1.2 Trusted Platform Module (TPM), Revision 62, Trusted Computing Group, released Oct. 2, 2003. A TPM is a microcontroller that stores keys, passwords and digital certificates, and may utilize a private communication bus for communicating with I/O controller 110.

FIG. 2 is a block diagram of an example authentication agent architecture, in accordance with one example embodiment of the invention. As shown, authentication agent 106 may include one or more of control logic 202, memory 204, controller interface 206, and authentication engine 208 coupled as shown in FIG. 2. In accordance with one aspect of the present invention, to be developed more fully below, authentication agent 106 may include an authentication engine 208 comprising one or more of decrypt services 210, valid services 212, and/or load services 214. It is to be appreciated that, although depicted as a number of disparate functional blocks, one or more of elements 202-214 may well be combined into one or more multi-functional blocks. Similarly, authentication engine 208 may well be practiced with fewer functional blocks, i.e., with only valid services 212, without deviating from the spirit and scope of the present invention, and may well be implemented in hardware, software, firmware, or any combination thereof. In this regard, authentication agent 106 in general, and authentication engine 208 in particular, are merely illustrative of one example implementation of one aspect of the present invention. As used herein, authentication agent 106 may well be embodied in hardware, software, firmware and/or any combination thereof.

As introduced above, authentication agent 106 may have the ability to lock values in chipset identification registers, to authenticate a signature of a chipset patch, and to validate the chipset patch based at least in part on the locked values. In one embodiment, authentication agent 106 may utilize stored secrets within electronic appliance 100. In another embodiment, authentication agent 106 may include software that operates in a protected execution environment in processor(s) 102.

As used herein control logic 202 provides the logical interface between authentication agent 106 and its host electronic appliance 100. In this regard, control logic 202 may manage one or more aspects of authentication agent 106 to provide a communication interface to electronic appliance 100, e.g., through memory controller 104.

According to one aspect of the present invention, though the claims are not so limited, control logic 202 may selectively invoke the resource(s) of authentication engine 208. As part of an example method to authenticate a chipset patch with cryptographic signatures, as explained in greater detail with reference to FIG. 3, control logic 202 may selectively invoke decrypt services 210 that may decrypt an encrypted chipset patch or chipset patch signature. Control logic 202 also may selectively invoke valid services 212 or load services 214, as explained in greater detail with reference to FIG. 3, to validate the chipset patch or load the chipset patch, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store cryptographic keys, passwords, certificates, or identification information, for example.

Controller interface 206 provides a path through which authentication agent 106 can communicate with memory controller 104. In one embodiment, controller interface 206 may represent any of a wide variety of interfaces or controllers known in the art. In another embodiment, controller interface 206 may comply with the System Management Bus (SMBus) Specification, Version 2.0, SBS Implementers Forum, released Aug. 3, 2000.

As introduced above, authentication engine 208 may be selectively invoked by control logic 202 to decrypt a chipset patch, to validate a chipset patch, or to load a chipset patch. In accordance with the illustrated example implementation of FIG. 2, authentication engine 208 is depicted comprising one or more of decrypt services 210, valid services 212 and load services 214. Although depicted as a number of disparate elements, those skilled in the art will appreciate that one or more elements 210-214 of authentication engine 208 may well be combined without deviating from the scope and spirit of the present invention.

Decrypt services 210, as introduced above, may provide authentication agent 106 with the ability to decrypt a chipset patch or digital signature. In one example embodiment, decrypt services 210 may function as part of a strong method of authentication such as RSA encryption/decryption using public/private keys. For the purpose of establishing a secure channel with the TPM, the other device would use a public key and the TPM would use a private key. A pseudo-random session key may be generated for communications with the TPM through a symmetric cryptosystem. A session key may be shared using an asymmetric cryptosystem. Secure communications can be established in this way between electronic appliance 100 and other devices, for example through a wired or wireless network, and secure communications can also be established between components within electronic appliance 100, for example between authentication agent 106 and a TPM I/O device 112. The chipset patch itself may be digitally signed and then encrypted or encrypted and then digitally signed. One example of a digital signature is the Digital Signature Standard (DSS) utilizing a Secure Hash Algorithm (for example, SHA-1).

As introduced above, valid services 212 may provide authentication agent 106 with the ability to validate a chipset patch. In one example embodiment, valid services 212 may compare an OEM identifier locked in a chipset identification register or stored in a TPM or memory 204 with an OEM identifier provided in a header or digital signature with a chipset patch. Valid services 212 may also compare a version or revision number stored in electronic appliance 100 with one provided with the chipset patch. In this way valid services 212 may be able to verify that the chipset patch is current and from the appropriate chipset vendor.

Load services 214, as introduced above, may provide authentication agent 106 with the ability to load the chipset patch. In one embodiment, after an authentication and validation of the chipset patch load services 214 may initiate a system boot or load in response to a system boot. In another example embodiment, load services 214 may run in a protected execution environment separate from any operating system (OS) or other instructions. Load services 214 may halt all other bus activity as well to prevent corruption of the chipset patch loading process. Load services 214 may initiate the load process by locking values, making them secure, in chipset identification registers that are utilized by valid services 212.

FIG. 3 is a flow chart of an example method to authenticate chipset patches with cryptographic signatures, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, method 300 begins with load services 214 being invoked to load and lock (302) chipset patch program into chipset programming registers. In one example embodiment, the values include an OEM identifier and a revision number. In another example embodiment, the values are stored in a TPM and securely shared with load services 214 through the use of cryptography.

Next, authentication agent 106 may isolate (304) the path to the chipset patch programming registers from other bus agents. In one example embodiment, load services 214 shuts down other bus activity during the load process. In another example embodiment, decrypt services 210 decrypts encrypted session keys and is also able to encrypt communications to a TPM or other devices. Decrypt services 210 may also provide a signal as to whether establishing secure communications was successful and the method should go forward.

Next, valid services 212 may verify (306) the composition of the locked data in the chipset patch programming registers. In one embodiment, valid services 212 compares a locked OEM identifier with an OEM identifier provided with a chipset patch. In another embodiment, other secret values are compared to determine whether to proceed to the next step.

Next, control logic 202 may selectively invoke load services 214 to fetch (308) the chipset patch data's authentication signature. In one example embodiment, load services 214 is run before the OS is loaded as part of a basic input/output system (BIOS) initialization.

Next, authentication agent 106 may authenticate (310) that the chipset patch programming is correct, using strong cryptographic authentication. In one embodiment, decrypt services 210 utilizes a SHA-1 hash reduction mechanism. If the chipset patch does not pass authentication, then the programming would be halted.

FIG. 4 illustrates a block diagram of an example storage medium comprising content which, when accessed by a device, causes the device to implement one or more embodiment(s) of the invention, for example authentication agent 106 and/or associated method 300. In this regard, storage medium 400 includes content 402 (e.g., instructions, data, or any combination thereof) which, when executed, causes the appliance to implement one or more aspects of authentication agent 106, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
locking values in chipset identification registers;
authenticating a signature of a chipset patch; and
validating the chipset patch based at least in part on the locked values.

2. The method of claim 1, further comprising:
loading the chipset patch.

3. The method of claim 1, wherein authenticating a signature of a chipset patch comprises:
decrypting a chipset patch with a public RSA authentication key.

4. The method of claim 1, further comprising:
authenticating the chipset patch in a protected execution environment.

5. The method of claim 1, wherein locking values comprises:
locking an original equipment manufacturer (OEM) identifier.

6. The method of claim 1, wherein validating the chipset patch comprises:
making use of secrets stored in a trusted privacy module (TPM).

7. An electronic appliance, comprising:
a processor;
a TPM;
a chipset; and
an authentication engine coupled with the processor, the TPM and the chipset, the authentication engine to lock values in chipset identification registers, to authenticate a signature of a chipset patch, to validate the chipset patch and to load the chipset patch.

8. The electronic appliance of claim 7, further comprising:
the authentication engine to decrypt the chipset patch with a public RSA authentication key.

9. The electronic appliance of claim 7, further comprising:
the authentication engine to utilize secrets stored in the TPM.

10. The electronic appliance of claim 7, wherein the processor comprises:
a processor capable of providing a protected execution environment.

11. A storage medium comprising content which, when executed by an accessing machine, causes the accessing machine to lock values in chipset identification registers, to authenticate a signature of a chipset patch, to validate the chipset patch and to load the chipset patch.

12. The storage medium of claim 11, further comprising content which, when executed by the accessing machine, causes the accessing machine to decrypt the chipset patch with a public RSA authentication key.

13. The storage medium of claim 11, further comprising content which, when executed by the accessing machine, causes the accessing machine to utilize secrets stored in a TPM.

14. The storage medium of claim 11, further comprising content which, when executed by the accessing machine, causes the accessing machine to execute content in a protected execution environment.

15. The storage medium of claim 11, wherein the content to lock values comprises content which, when executed by the accessing machine, causes the accessing machine to lock an original equipment manufacturer (OEM) identifier.

16. An apparatus, comprising:
a chipset interface;
a processor interface;
a TPM interface; and
control logic coupled with the chipset, processor and TPM interfaces, the control logic to lock values in chipset identification registers, to authenticate a signature of a chipset patch, to validate the chipset patch and to load the chipset patch.

17. The apparatus of claim 16, further comprising control logic to decrypt the chipset patch with a public RSA authentication key.

18. The apparatus of claim 17, further comprising control logic to utilize secrets stored in the TPM.

19. The apparatus of claim 18, further comprising control logic to utilize a protected execution environment of the processor.

20. The apparatus of claim 19, wherein the control logic to lock values comprises control logic to lock an original equipment manufacturer (OEM) identifier.
